(19) United States
(12) Patent Application Publication
(10) Pub. No.: US 2007/0241901 A1
(43) Pub. Date: Oct. 18, 2007

(54) System and method for object tracking via tag readings

(75) Inventors: James D. Cage, Duluth, GA (US); Yu-Gene T. Chen, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/394,935

(22) Filed: Mar. 31, 2006

(51) Int. Cl. G08B 13/14; G06K 13/00; G08B 5/22

(52) U.S. Cl. 340/572.1; 340/825.49; 235/485

(57) ABSTRACT

A system for tracking an object associated with a mobile tag reader includes a first identification tag capable of providing a first set of location information associated with the first identification tag. The system also includes a second identification tag capable of providing a second set of location information associated with the first identification tag. In addition, the system includes a controller capable of correlating the first set of location information and the second set of location information to predict a current location of the object.

### TECHNICAL FIELD

This disclosure relates generally to tracking systems and more particularly to a system and method for object tracking via tag readings.

### BACKGROUND

Many radio frequency identification (RFID) applications are directed to objects that need tracking, such as people, animals, vehicles, and merchandise. Specifically, RFID has been applied to animal tracking, controlled access to buildings or restricted areas, inventory management, theft detection, toll road collections, libraries, and in retail checkouts. In most applications, an RFID transponder or “tag” is affixed to a moveable object. In other applications, the RFID reader is associated with the moveable object and a fixed RFID tag is associated with a particular location or other object. A transceiver or RFID reader detects the presence of the RFID tag and performs either a tracking or counting function according to the specific application at hand.

In certain RFID applications, such as an application in which an RFID system tracks workers in a given area, it is often difficult to assess in a short time frame the location of every person in the given area. This information can be very important, especially when manual tasks need to be performed urgently or in the case of an emergency.

### SUMMARY

This disclosure generally provides a system and method for object tracking via tag readings.

In a first embodiment, a system for tracking an object associated with a mobile tag reader includes a first identification tag capable of providing a first set of location information associated with the first identification tag. The system also includes a second identification tag capable of providing a second set of location information associated with the second identification tag. In addition, the system includes a controller capable of correlating the first set of location information and the second set of location information to predict a current location of the object.

In a second embodiment, a method for tracking an object associated with a mobile tag reader includes receiving a first set of location information associated with a first identification tag from the mobile tag reader. The method also includes receiving a second set of location information associated with a second identification tag from the mobile tag reader. In addition, the method includes correlating the first set of location information and the second set of location information to predict a current location of the object.

In a third embodiment, a computer program is embodied on a computer readable medium and is capable of being executed by a processor. The computer program includes computer readable program code for receiving a first set of location information associated with a first identification tag from a mobile tag reader, where the mobile tag reader is associated with an object. The computer program also includes computer readable program code for receiving a second set of location information associated with a second identification tag from the mobile tag reader. In addition, the computer program includes computer readable program code for correlating the first set of location information and the second set of location information to predict a current location of the object.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example tracking system;

FIG. 2 illustrates an example tracking system according to one embodiment of this disclosure; and

FIG. 3 illustrates an example method for object tracking via tag readings according to one embodiment of this disclosure.

### DETAILED DESCRIPTION

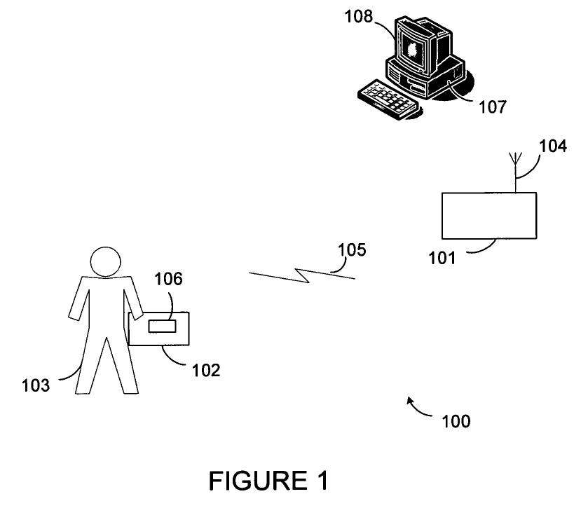

FIG. 1 illustrates an example tracking system 100. In this example, the system 100 includes tag 101 and mobile tag reader 102 attached to or associated with an object 103.

The tag reader 102 is configured to detect the tag 101 when the tag 101 is within a given proximity. The tag reader 102 generally represents any suitable device or structure for obtaining information from the tag 101. The tag reader 102 could, for example, represent an RFID tag reader, a bar code reader, or a smartcard reader. The tag reader 102 could also be compatible with, for example, a global positioning system (GPS) or a voice over Internet protocol (VoIP) system.

The tag 101 generally represents any suitable device or structure for identifying or recognizing, for example, an associated location or another object. The tag 101 could, for example, represent a radio frequency identification (RFID) tag, a tag with a bar code, or a smartcard. The tag 101 could also be compatible with a global positioning system (GPS) or a voice over Internet protocol (VoIP) system. While shown as a person in FIG. 1, the object 103 may represent any other suitable object, such as a food item, a machine part, an animal, or other object requiring tracking or some type of accounting. In this example, the tag 101 includes an antenna 104 for wireless communication with the tag reader 102. The tag 101 may represent an “active tag” powered by an internal battery or a “passive tag” where an inductive coupling induces power from RF signals received by the tag 101.

As shown in FIG. 1, the tag reader 102 interrogates the tag 101 via an RF link 105. A controller 106 in the tag reader 102 may in turn interface with a host controller or system 107. The controller 106 may hardwired to the host system 107 or connected via a wireless interface to the host system 107. The host system 107 generally directs the interrogation of the tag 101 depending upon the requirements of the system 100. The host system 107 may represent any processing unit, such as a network computer, a stand-alone computer, or other central processing devices. The host system 107 may be configured to display information gathered by the system 100 on a display unit 108. The display unit 108 may, for example, be a computer monitor or other terminal. The host system 107 may be further configured to share information gathered by the system 100 with other host systems or other display devices, such as a mobile telephone, a PDA, a stand-alone unit, a terminal, or other device. The system 100 thus provides a means for identifying, monitoring, and controlling an object 103 in a closed loop process.

The system 100 may track the location of an object 103 by recording the interrogation of a particular tag 101 by the tag reader 102 and identifying the associated location or the completion of a particular task. For example, FIG. 1 illustrates the object 103 in proximity to the tag reader 102. If the object 103 is a person who is recording data gathered at a location proximate to the tag 101, the tag reader 102 may read information from the tag 101 via the RF link 105. The controller 106 conveys the information associated with the tag 101 to the host system 107. This information may include, for example, the data gathered by the object 103, any information associated with the tag 101, the location of the tag 101 (which, based on the method of reading the tag 101 defines the position of object 103) and time stamp information identifying when the tag reader 102 attempted to read information from the tag 101. The host system 107 generally receives this information and uses it according to the specific system 100 or the application at hand.

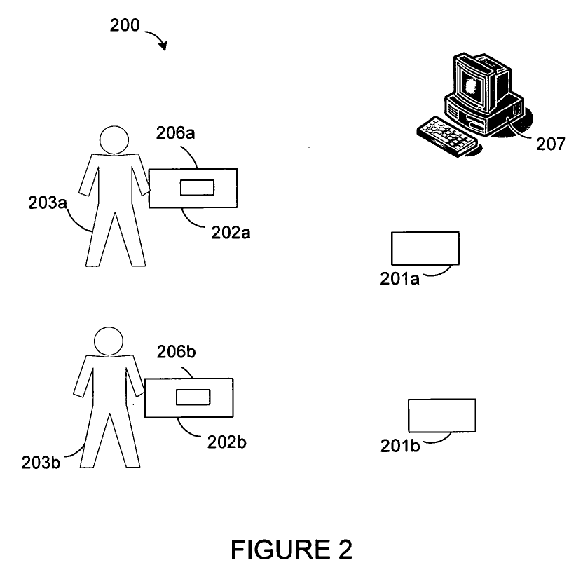

FIG. 2 illustrates an example tracking system 200 according to one embodiment of this disclosure. The embodiment of the tracking system 200 shown in FIG. 2 is for illustration only. Other embodiments of the tracking system 200 may be used without departing from the scope of this disclosure.

In this example, the system 200 includes two or more mobile tag readers 202a and 202b having controllers 206a and 206b (collectively referred to as controllers 206), respectively. This may be useful, for example, in large factory floors or other larger areas. The controllers 206 are configured to communicate with a host system 207. A number of authorized fixed tags, such as tags 201a and 201b, may be assigned to different locations or tasks. If an object or employee 203a carries the tag reader 202a and enters the factory floor near the tag 201a, the controller 206a interrogates the tag 201a and obtains the appropriate information from the tag 201a. The host system 207 receives the information associated with the tag 201a from the controller 206a and records the information. The information may include, for example, the identification of the tag 201a, the location of the tag 201a, and the time of access.

If the employee 203a then moves to another factory location associated with the tag 201b, the host system 207 again receives similar information from the controller 206b and the tag 201b. This process may continue throughout the day, where the employee 203a associated with the tag reader 202a is tracked. Moreover, the host system 207 may, as described in more detail below, track the actual location of the employee 203a and/or estimate the current location of the employee 203a.

If the factory floor experiences an emergency and the employee 203b needs to locate the employee 203a as soon as possible, the employee 203b may access the host system 207 and query for information regarding the employee 203a. The employee 203b may choose to receive the last known location of the employee 203a. The host system 207 in this case searches its records and finds that the employee 203a last recorded an access at a particular tag (such as tag 201b) at a certain time. The employee 203b may then use that information to attempt to find employee 203b.

The host system 207 may also predict the current location of the employee 203a by correlating the patterns of movement recorded by the host system 207. For example, based on the previous movement patterns of the employee 203a, the host system 207 may predict that the employee 203a is now most likely to be near the tag 201a. The employee 203b may now look for the employee 203a in the vicinity of the tag 201a.

The host system 207 is thus configured to track the movements of the employees 203a-203b generally simultaneously, such as by using a location software application that generates a best estimate of an employee or other object's position based on the current time, derived patterns of movement, and recently recorded movement data.

FIG. 2 illustrates one example of the tracking system 200 in which the tag reader 202 is a mobile unit associated with the object 203 and capable of detecting a fixed version of the tag 201. The tracking system 200 may also include a mobile version of the tag 201 associated with the object 203 capable of being detected by a fixed version of the tag reader 202.

Although FIG. 2 illustrates one example of a tracking system 200, various changes may be made to FIG. 2. The system 200 could also include any number of tags 201, tag readers 202, objects 203, and host systems 207.

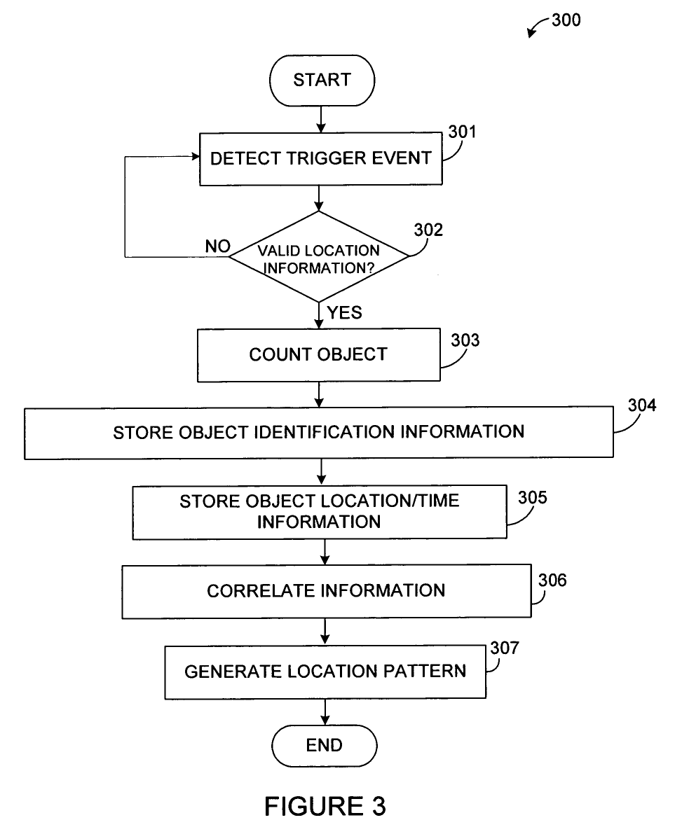

FIG. 3 illustrates an example method 300 for object tracking via tag readings according to one embodiment of this disclosure. For ease of explanation, the method 300 is described with respect to the tracking system 200 of FIG. 2. The method 300 could be used by any other suitable system.

The method 300 begins in step 301 when one of the controllers detects a triggering event. A triggering event may occur, for example, when the tag 201a is detected by the controller 206a. A triggering event might also be when the user manually enters information about a location or task. In step 302, the controller ascertains whether the information read from the tag includes location information, if the location of the tag location is already known to the system, or if the manually entered task typically takes place at a known location. If the controller ascertains that it is not possible to read or deduce valid location information, the controller does not count the object. The controller could also take any other suitable action, such as requesting location information from the user or operator, requesting that the operator move to another location, or sounding an alarm. Also, if it is not possible to read or deduce valid location information, the method 300 may then remain idle until another triggering event occurs. On the other hand, if valid location information is found, the controller counts the object in step 303.

After accounting for the object 103, the host system 207 stores information read from the tag by the controller in step 304. In step 305, the host system 207 stores other information associated with the tag, such as the identification, location of the interrogating controller and time stamp information associated with the interrogation. Suppose, for example, a user's tag reader 202a detects the tag 201a located at a particular factory entrance. The host system 207 may store the identification of the holder 203 of the tag reader 202, the identification of the controller 206a, and a time of entry.

In step 306, the host system 207 begins correlating similar information throughout a given time period for the tag reader and any other tag readers within the system 200. For each tag reader 202 in the system, the host system 207 derives movement patterns for each tag reader in step 307. Also in step 307, the host system 207 generates a “best estimate” of each tag reader's position by combining these patterns using the most current proximity data. The host system 207 may, for example, generate a “best estimate” using a location software application or other similar algorithms. The host system 207 may then make this information available to any person, such as people authorized to access the information.

Although FIG. 3 illustrates one example of a method 300 for object tracking via tag readings, various changes may be made to FIG. 3. For example, while shown as a series of steps, various steps in FIG. 3 could occur in parallel or in a different order.

It may be advantageous to set forth definitions of certain words and phrases used throughout this patent document. The term “couple” and its derivatives refer to any direct or indirect communication between two or more elements, whether or not those elements are in physical contact with one another. The term “application” refers to one or more computer programs, sets of instructions, procedures, functions, objects, classes, instances, or related data adapted for implementation in a suitable computer language. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system for tracking an object associated with a mobile tag reader, comprising:
a first identification tag capable of providing a first set of location information associated with the first identification tag;
a second identification tag capable of providing a second set of location information associated with the second identification tag; and
a controller capable of correlating the first set of location information and the second set of location information to predict a current location of the object.

2. The system of claim 1, wherein the first identification tag and the second identification tag comprise a radio frequency identification (RFID) tag; and wherein the mobile tag reader comprises a RFID reader.

3. The system of claim 1, wherein the first identification tag and the second identification tag comprise a bar code; and wherein the mobile tag reader comprises a bar code reader.

4. The system of claim 1, wherein the first identification tag and the second identification tag comprise at least one of: an active radio frequency identification (RFID) tag and a passive RFID tag.

5. The system of claim 1, wherein the first identification tag and the second identification tag are compatible with at least one of: a global positioning system (GPS) and a voice over Internet Protocol (VoIP) system.

6. The system of claim 1, wherein at least one of the first identification tag and the second identification tag is a fixed tag.

7. The system of claim 1, wherein the first set of location information comprises at least one of: a known location of the first identification tag and time stamp information associated with the collection of the first set of location information.

8. The system of claim 1, wherein the second set of location information comprises at least one of: a known location of the second identification tag and time stamp information associated with the collection of the second set of location information.

9. The system of claim 1, wherein the object comprises at least one of: a person, an animal, and a product.

10. A method for tracking an object associated with a mobile tag reader, comprising:
receiving a first set of location information associated with a first identification tag from the mobile tag reader;
receiving a second set of location information associated with a second identification tag from the mobile tag reader; and
correlating the first set of location information and the second set of location information to predict a current location of the object.

11. The method of claim 10, wherein the first identification tag and the second identification tag comprise a radio frequency identification (RFID) tag; and wherein the mobile tag reader comprises a RFID reader.

12. The method of claim 10, wherein the first identification tag and the second identification tag comprises a bar code; and wherein the mobile tag reader comprises a bar code reader.

13. The method of claim 10, wherein the first identification tag and the second identification tag comprise at least one of: an active radio frequency identification (RFID) tag and a passive RFID tag.

14. The method of claim 10, wherein the first identification tag and the second identification tag is compatible with at least one of: a global positioning system (GPS) and a voice over Internet protocol (VOIP) system.

15. The method of claim 10, wherein at least one of the first identification tag and the second identification tag is a fixed tag.

16. The method of claim 10, wherein the first set of location information comprises at least one of: a known location of the first tag and time stamp information associated with the collection of the first set of location information.

17. The method of claim 10, wherein the second set of location information comprises at least one of: a known location of the second tag and time stamp information associated with the collection of the second set of location information.

18. The method of claim 10, wherein the object comprises at least one of: a person, an animal, and a product.

19. A computer program embodied on a computer readable medium and capable of being executed by a processor, the computer program comprising computer readable program code for:
receiving a first set of location information associated with a first identification tag from a mobile tag reader, where the mobile tag reader is associated with an object;
receiving a second set of location information associated with a second identification tag from the mobile tag reader; and
correlating the first set of location information and the second set of location information to predict a current location of the object.

20. The computer program of claim 19, wherein the first identification tag and the second identification tag comprise a radio frequency identification (RFID) tag.

21. The computer program of claim 19, wherein the first identification tag and the second identification tag comprise a bar code.

22. The computer program of claim 19, wherein the first identification tag and the second identification tag are compatible with at least one of: a global positioning system (GPS) and a voice over Internet Protocol (VOIP) system.

23. The computer program of claim 19, wherein the computer readable program code for correlating the first set of location information and the second set of location information comprises computer readable program code for predicting the current location of an employee.

24. A system for tracking an object associated with an identification tag, comprising:
a first tag reader capable of generating a first set of location information associated with the identification tag;
a second tag reader capable of generating a second set of location information associated with the identification tag; and
a controller capable of correlating the first set of location information and the second set of location information to predict a current location of the object.

25. The system of claim 22, wherein at least one of the first tag reader and the second tag reader is mobile.
